(19) United States
(12) Patent Application Publication
(10) Pub. No.: US 2022/0018711 A1
(43) Pub. Date: Jan. 20, 2022

(54) ULTRAVIOLET DETECTION DEVICE, INTELLIGENT APPARATUS, AND PREPARATION METHOD

(71) Applicant: BOE Technology Group Co., Ltd., Beijing (CN)

(72) Inventor: Zheng Wu, Beijing (CN)

(73) Assignee: BOE Technology Group Co., Ltd., Beijing (CN)

(21) Appl. No.: 17/289,559

(22) PCT Filed: Aug. 5, 2020
(86) PCT No.: PCT/CN2020/107111

§ 371 Date: Apr. 28, 2021

(30) Foreign Application Priority Data
Sep. 6, 2019 (CN) 201910842735.1

(51) Int. Cl. G01J 1/50

(52) U.S. Cl. CPC G01J 1/50

(57) ABSTRACT

An ultraviolet-ray detecting device, a smart apparatus and a fabricating method. The ultraviolet-ray detecting device has: a substrate (1); and a plurality of identification regions (2), wherein each of the identification regions (2) includes an ultraviolet-photochromic marker (3) on the substrate (1) and a cover (4) covering the ultraviolet-photochromic marker (3), wherein ultraviolet-ray blocking capacities of the covers (4) in the identification regions (2) are different.

### CROSS REFERENCE TO RELEVANT APPLICATIONS

The present disclosure claims the priority of the Chinese patent application filed on Sep. 6, 2019 with the application number of 201910842735.1, which is incorporated herein in its entirety by reference.

### TECHNICAL FIELD

The present disclosure relates to an ultraviolet-ray detecting device, a smart apparatus and a fabricating method.

### BACKGROUND

As is well known, excessive ultraviolet irradiation causes a huge harm to human body. UVR (Ultraviolet Ray) comprises UVA (the wavelength of 315-400 nm), UVB (the wavelength of 280-315 nm) and UVC (the wavelength of 100-280 nm) of different wavelengths, and the wave bands have influences on human body very differently. The atmosphere filters out most of the UVB and all of the UVC in sunlight, and, therefore, the UVR reaches the earth surface mainly comprises the UVA and the UVB. However, the damage on human body by the UVA and UVB ultraviolet rays still exists, especially on people who are sensitive to ultraviolet rays.

Currently, portable products that can timely alert the user the ultraviolet intensity still require improvement.

### SUMMARY

The present disclosure provides an ultraviolet-ray detecting device, wherein the ultraviolet-ray detecting device comprises:

a substrate, wherein the substrate comprises a plurality of identification regions; and

an ultraviolet-photochromic marker and a cover covering the ultraviolet-photochromic marker that are in each of the identification regions, wherein ultraviolet-ray blocking capacities of the covers in the identification regions are different.

Optionally, the ultraviolet-photochromic marker is formed by an ultraviolet-photochromic ink, wherein the ultraviolet-photochromic ink is a mixture of an aqueous solution of an ultraviolet-photochromic polyoxometallate and an aqueous solution of an electron donor.

Optionally, a ratio of molar concentrations of the aqueous solution of the ultraviolet-photochromic polyoxometallate to the aqueous solution of the electron donor is in a range of 1:10 to 1:120.

Optionally, the ultraviolet-photochromic polyoxometallate is a phosphomolybdate.

Optionally, the electron donor is at least one of oxalic acid, glycolic acid and lactic acid.

Optionally, the covers having the different ultraviolet-ray blocking capacities are ultraviolet-ray blocking films having different quantities of stacked layers.

Optionally, the plurality of identification regions are arranged so that the quantities of the stacked layers of the ultraviolet-ray blocking films in the identification regions are progressively increased or progressively reduced in an arranging sequence.

Optionally, the ultraviolet-ray blocking films are marked with ultraviolet-resistance degrees based on the quantities of the stacked layers.

In another aspect, the present disclosure provides a smart apparatus, comprising a housing, wherein the smart apparatus further comprises the ultraviolet-ray detecting device stated above, and the ultraviolet-ray detecting device is arranged at the housing.

Optionally, the smart apparatus further comprises:

an image collecting component configured for collecting image information of the ultraviolet-photochromic markers of the ultraviolet-ray detecting device; and

a data analyzing component configured for, according to the image information, acquiring intensity information of an ultraviolet ray, determining whether the intensity information exceeds a preset threshold, and when the preset threshold is exceeded, generating an alerting signal.

Optionally, the smart apparatus further comprises an alarming device configured for, according to the alerting signal, emitting alarming information, wherein the alarming information comprises sound alarming information and/or visual alarming information.

Optionally, the ultraviolet-ray detecting device is detachably arranged at the housing.

In yet another aspect, the present disclosure provides a fabricating method of an ultraviolet-ray detecting device, wherein the method comprises:

preparing an ultraviolet-photochromic ink;

delimiting a plurality of identification regions on a substrate;

spreading the ultraviolet-photochromic ink in each of the identification regions, to form ultraviolet-photochromic markers; and

in the identification regions, covering the ultraviolet-photochromic markers by using covers having different ultraviolet-ray blocking capacities.

Optionally, the step of preparing the ultraviolet-photochromic ink comprises:

providing an aqueous solution of an ultraviolet-photochromic polyoxometallate and an aqueous solution of an electron donor; and

mixing the aqueous solution of the ultraviolet-photochromic polyoxometallate and the aqueous solution of the electron donor.

Optionally, after the step of preparing the ultraviolet-photochromic ink and before the step of spreading the ultraviolet-photochromic ink in each of the identification regions to fabricate the markers, the method comprises protecting the ultraviolet-photochromic ink from light and by using nitrogen sealing.

### BRIEF DESCRIPTION OF THE DRAWINGS

In the drawings, which are not necessarily drawn to scale, the same reference numbers may indicate similar elements in different figures. The same reference numbers having letter suffixes or different letter suffixes may indicate different examples of similar elements. The drawings generally show the embodiments for illustration rather than limitation, and illustrate the disclosed embodiments together with the description and the claims. If appropriate, the same reference numbers refer to the same or similar parts in all of the drawings. Those embodiments are illustrative, and are not intended to serve as exhaustive or exclusive embodiments of the device or method.

FIGS. 1A-1B are schematic diagrams of an embodiment of the ultraviolet-ray detecting device according to the present disclosure;

FIG. 2 is a schematic diagram of an embodiment of the relation between the displaying result of the ultraviolet-ray detecting device and the irradiation intensity of the ultraviolet ray according to the present disclosure;

FIG. 3 is a flow chart of an embodiment of the fabricating method of an ultraviolet-ray detecting device according to the present disclosure; and

FIG. 4 is a schematic structural diagram of an embodiment of the smart apparatus according to the present disclosure.

### DETAILED DESCRIPTION

In order to enable a person skilled in the art to better understand the technical solutions of the present disclosure, the present disclosure will be described in detail below with reference to the drawings and the particular embodiments. The embodiments of the present disclosure will be described in further detail below with reference to the drawings and the particular embodiments, which are not intended to limit the present disclosure.

The words used herein such as “first” and “second” do not indicate any sequence, quantity or priority, but are merely intended to distinguish different parts. The words such as “comprise” or “include” mean that the element preceding the word encompasses the elements that are listed subsequent to the word, but do not exclude the possibility of encompassing other elements. The words such as “upper”, “lower”, “left” and “right” are merely intended to indicate relative positions, and if the absolute position of the described item has changed, the relative positions might also be correspondingly changed.

In the present disclosure, if it is described that a particular device is located between a first device and a second device, there may be an intermediate device between the particular device and the first device or the second device, and there may also not be an intermediate device. If it is described that a particular device is connected to another device, the particular device may be directly connected to the another device without an intermediate device, and may also be indirectly connected to the another device, with an intermediate device therebetween.

All of the terms used herein (including technical terminologies or scientific terminologies) have the meanings that are the same as those generally understood by a person skilled in the art that the present disclosure relates to, unless defined otherwise specially. It should also be understood that the terms that are defined in, for example, a generic dictionary should be interpret as having the meanings that are consistent with the meanings of them in the context of the related art, and should not be interpreted in an idealized or extremely formalized manner, unless so defined expressly herein.

The techniques, methods and devices that a person skilled in the art has already known might not be discussed in detail, but, if appropriate, such techniques, methods and devices should be considered as part of the description.

The present disclosure provides an ultraviolet-ray detecting device, a smart apparatus and a fabricating method, which enables the user to monitor the intensities of ultraviolet irradiations in everyday life, to facilitate the user to timely prevent continuous irradiation under an ultraviolet irradiation of a high intensity.

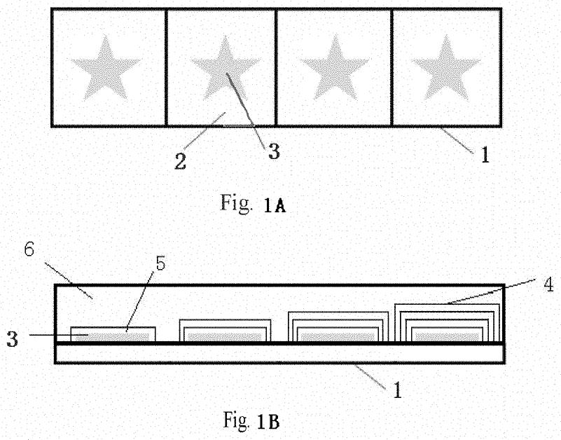

The present disclosure provides an ultraviolet-ray detecting device. FIGS. 1A-1B are schematic diagrams of an embodiment of the ultraviolet-ray detecting device according to the present disclosure. As shown in FIGS. 1A and 1B, the ultraviolet-ray detecting device comprises a substrate 1. The substrate 1 is divided into a plurality of identification regions 2. The identification regions 2 may be sequentially arranged in a certain sequence, and may also be arranged in a certain curve or circle shape, which is not particularly limited in the present disclosure. FIG. 1A shows that the substrate 1 is divided into four identification regions 2 that are arranged in a row. In each of the identification regions, an ultraviolet-photochromic marker 3 and a cover 4 that covers the ultraviolet-photochromic marker are provided. The ultraviolet-photochromic marker refers to a marker whose color is changed under ultraviolet-light irradiation. In the identification regions, the ultraviolet-ray blocking capacities of the covers are different.

As shown in FIG. 1B, the covers 4 may be formed by a plurality of ultraviolet-ray blocking films 5 having different quantities of stacked layers. In the rightmost identification region, the cover 4 comprises 4 layers of ultraviolet-ray blocking films 5, while in the leftmost identification region, the cover 4 is a single layer of ultraviolet-ray blocking film 5. When the ultraviolet-ray blocking capacities of all of the ultraviolet-ray blocking films 5 are the same, because the quantities of the stacked layers of the ultraviolet-ray blocking films in the 4 identification regions are different, the ultraviolet-ray blocking capacities of the covers progressively increase in the identification regions from left to right.

Certainly, the covers having different ultraviolet-ray blocking capacities may also be formed not by using the ultraviolet-ray blocking films having different quantities of stacked layers. For example, the covers may also be formed by using ultraviolet-ray blocking films that have the same thickness but have different ultraviolet-ray blocking capacities.

In brief, for an ultraviolet ray, the cover has a certain light transmittance, to enable the ultraviolet ray of a certain intensity to pass through the cover, and also has a certain opacity. In other words, different covers have different effects of blocking or obstructing an ultraviolet ray. When the covers are formed by using the same material, that may be realized by using covers of different thicknesses or covering layers of different quantities of layers. If the employed covers have higher thicknesses or higher quantities of layers, the effect of the covers of blocking or obstructing an ultraviolet ray is more obvious.

A requirement on the cover is that it is transmittable to the color of the visible light generated by the ultraviolet photochromism, whereby the change in color caused by the ultraviolet photochromism can be observed through the cover. For example, the cover is transparent or translucent to visible light. Another requirement on the cover is that its position is set so that it can block the ultraviolet ray irradiating from the environment to the ultraviolet-photochromic marker.

The device may further be provided with, if appropriate, a flat layer 6 and so on, which is not particularly limited in the present disclosure. Such a flat layer is merely required to have substantially no influence on the transmission of visible light and ultraviolet light.

An ultraviolet-photochromic ink that has been completely prepared may be sucked by using a fountain pen or a brush pen, and the ultraviolet-photochromic markers 3 may be formed by using the ultraviolet-photochromic ink in each of the identification regions 2. The ultraviolet-photochromic ink on the substrate may be drawn into patterns of an easily identifiable shape such as five-pointed stars and circles by hand-drawn marking, to facilitate the user to observe.

In the ultraviolet-ray detecting device according to the present disclosure, the ultraviolet-photochromic marker 3 will discolor under an ultraviolet irradiation. As the intensity of the ultraviolet irradiation increases, the color of the ultraviolet-photochromic marker 3 can gradually darken. In other words, the darkness of the color of the ultraviolet-photochromic marker 3 is related to the intensity of the ultraviolet irradiating on the marker, and may be used to characterize different ultraviolet intensities.

As different from the conventional solution that a single one ultraviolet-photochromic marker is employed and the discoloration result is compared with a pre-prepared colorimetric card to measure the ultraviolet intensity, the device according to the present disclosure realizes different actual irradiation intensities by providing the different covers in the different identification regions, and realizes the measurement on the ultraviolet intensity by comparing the colors of the different identification regions. The device according to the present disclosure can avoid the comparison with the pre-prepared colorimetric card, which comparison is frequently difficult for the user. By properly controlling the parameters of the covers and the markers, the device according to the present disclosure can enable the identification regions to have color development under different environmental-ultraviolet threshold intensities, and, by arranging the identification regions in order, can enable the user to easily determine the ultraviolet intensity of the current environment.

Typically, in each of the identification regions, under the irradiation of ultraviolet lights of the same intensity, the same discoloration results are obtained. For example, ultraviolet-photochromic markers of the same thickness and the same material may be used, but their patterns may be different. Accordingly, under the irradiation of the same ambient light, the difference between the discoloration results of the ultraviolet-photochromic markers of the different identification regions totally depends on the covers. When the identification regions 2 of the ultraviolet-photochromic markers 3 are covered by the covers, if one of them is covered by a cover having a higher capacity of blocking an ultraviolet ray, for example an ultraviolet-ray blocking film having a higher quantity of covering layers or a higher thickness, the effect of blocking or obstructing an ultraviolet ray is higher, and the corresponding identification region 2 has more difficulty in receiving the ultraviolet irradiation. As the intensities of the ultraviolet irradiation received by the identification regions 2 are increasingly lower, the colors of the ultraviolet-photochromic ink on the identification regions 2 are increasingly lighter, and even cannot easily discolor. If one of them is covered by a cover having a lower capacity of blocking an ultraviolet ray, for example an ultraviolet-ray blocking film having a lower quantity of covering layers or a lower thickness, the effect of blocking or obstructing an ultraviolet ray is weaker, the corresponding identification region 2 has lower difficulty in receiving the ultraviolet irradiation, and the ultraviolet-photochromic ink on the identification region 2 can more easily discolor, and have a darker color.

In some embodiments, the covers comprise ultraviolet-ray blocking films having different quantities of stacked layers, and the identification regions 2 on the substrate 1 may be arranged in a sequence in which the quantities of the stacked layers of the covering ultraviolet-ray blocking films are progressively increased or progressively reduced. In other words, the plurality of identification regions are arranged so that the quantities of the stacked layers of the ultraviolet-ray blocking films in the identification regions are progressively increased or progressively reduced in an arranging sequence. The different identification regions 2 arranged in a sequence are covered by the ultraviolet-ray blocking films whose quantities of the layers are progressively increased or progressively reduced, so that the darknesses of the colors of the ultraviolet-photochromic markers 3 are changed in a certain sequence. That facilitates the user to determine the irradiation intensity of an ultraviolet ray by observing the discoloration in a sequence of the identification regions 2. In addition, the quantities of the stacked layers of the ultraviolet-ray blocking films in the different identification regions 2 may be set according to requirements by the measurement by the user, to increase the adaptability of the product. For example, as shown in FIG. 1B, the quantities of the stacked layers of the ultraviolet-ray blocking films are progressively increased from 1 to 4 in the identification regions from left to right.

In some embodiments, the ultraviolet-ray blocking films are marked with ultraviolet-resistance degrees based on the quantities of the stacked layers. The identification regions 2 are marked with different ultraviolet-resistance degrees corresponding to the quantities of the stacked layers of the ultraviolet-ray blocking films, whereby the user, in practical usage, can identify the irradiation intensity of an ultraviolet ray according to the quantities of the layers of the ultraviolet-ray blocking films in the different identification regions 2, and in turn acquire the ultraviolet-resistance degree, so as to prepare the corresponding protection.

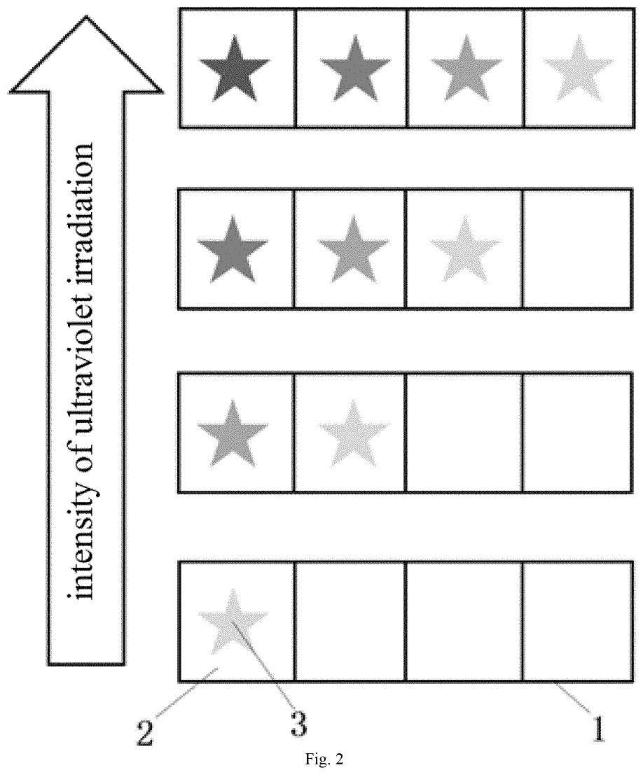

For example, FIG. 1 is the state of all of the ultraviolet-photochromic markers 3 in the identification regions 2 of the ultraviolet-ray detecting device before an ultraviolet irradiation, and FIG. 2 is the state of the progressively darkened discoloration of the ultraviolet-photochromic markers 3 in the identification regions 2 as the intensity of the ultraviolet irradiation is continuously increasing. The user can acquire the intensity of the ultraviolet irradiation of the current environment with naked eye according to the colors of the ultraviolet-photochromic markers 3 in the different identification regions 2. When it has been found that the intensity of the ultraviolet irradiation is too high, the user can make the protection according to his own situation, to prevent the irradiation of the ultraviolet ray of the high intensity.

The present disclosure, by using the characteristic of the ultraviolet-photochromic markers 3 of the ultraviolet-ray detecting device, i.e., the characteristic of the ultraviolet-photochromic markers 3 that the color is darkened under an ultraviolet irradiation of a high intensity, enables the user to monitor in real time the intensities of ultraviolet irradiations in everyday life, to acquire the intensity of the ultraviolet irradiation of his current environment at any time and at any place, and, when the intensity of the ultraviolet irradiation is too high, emit a protection alarming timely by using the ultraviolet-ray detecting device. Moreover, the component compositions of the ultraviolet-photochromic markers 3 or the quantities of the stacked layers of the ultraviolet-ray blocking films may be regulated, to realize customized designs for different people.

In some embodiments, the ultraviolet-photochromic marker is formed by an ultraviolet-photochromic ink, wherein the ultraviolet-photochromic ink is a mixture of an aqueous solution of an ultraviolet-photochromic polyoxometallate and an aqueous solution of an electron donor, in which the electron donor reduces the ultraviolet-photochromic polyoxometallate stepwisely under a certain condition. The combination of the ultraviolet-photochromic polyoxometallate and the electron donor is known in the art. Such a combination is particularly suitable for the solutions of the present disclosure, because it can easily form the desired ultraviolet-photochromic marker, and its ultraviolet-photochromic property is easily controllable by the concentration relation between the two components. The ultraviolet-photochromic polyoxometallate, under the condition of the electron donor and the ultraviolet irradiation, can realize multi-step reduction, thereby obtaining a series of intermediate products of multiple valence states; in other words, the ultraviolet-photochromic polyoxometallate emerges directly with different colors, whereby the ultraviolet-photochromic marker 3 has the characteristic that the color is darkened under an ultraviolet irradiation of a high intensity, and, thus, can, under different intensities of ultraviolet irradiations, display the colors of its different intermediate products to the user. The ultraviolet-photochromic ink itself may serve as the ultraviolet-photochromic marker. Alternatively, the ultraviolet-photochromic ink may also form the ultraviolet-photochromic marker after it has been semi-dried or dried. Preferably, the marker formed after the ink has been dried is employed, which facilitates the subsequent covering by the cover.

The ultraviolet-photochromic ink may be prepared at any time for the monitoring of ultraviolet irradiations. If the ultraviolet-photochromic ink is not to be used immediately after it is prepared, considering the disadvantage of the ultraviolet-photochromic ink of easy deterioration when exposed to sunlight, after the preparation of the ultraviolet-photochromic ink and before the usage, it may be stored with protection from light, to effectively protect the effectiveness and the durability of the ultraviolet-photochromic ink. For example, the prepared ultraviolet-photochromic ink is protected by using nitrogen, which is an inert gas.

In some embodiments, a ratio of molar concentrations of the aqueous solution of the ultraviolet-photochromic polyoxometallate to the aqueous solution of the electron donor is in a range of 1:10 to 1:120. Preferably, they are formulated with a concentration ratio of 1:60. For example, in formulation, certain volumes of an aqueous solution of the ultraviolet-photochromic polyoxometallate of 10 millimoles per liter and of an aqueous solution of the electron donor of 600 millimoles per liter are individually formulated. When they are required to be used, the aqueous solution of the ultraviolet-photochromic polyoxometallate of 10 millimoles per liter and the aqueous solution of the electron donor of 600 millimoles per liter are mixed with equal volumes, and an ultraviolet-photochromic ink containing 5 millimoles per liter of the ultraviolet-photochromic polyoxometallate and 300 millimoles per liter of the electron donor can be obtained. That ratio is a usual ratio of the concentration ratio of the aqueous solutions of the ultraviolet-photochromic polyoxometallate and of the electron donor; however, because different people have different degrees of tolerance to an ultraviolet ray, personalized customization based on different conditions of people is required. For example, for users such as children and the aged, they are people who are extremely sensitive to an ultraviolet ray, and they have a low degree of tolerance to an ultraviolet ray of a certain intensity. In addition, female users, considering the demand on aesthetic appeal, have a degree of tolerance to an ultraviolet ray lower than that of male users. Therefore, personalized customization for users may be performed by taking into consideration the factors such as the physiques and the ages of different users, in the following two manners. One of the manners is to, according to the difference in the physiques of the users, regulate the concentration ratio of the aqueous solution of the ultraviolet-photochromic polyoxometallate to the aqueous solution of the electron donor. For example, the concentration of the electron donor is adjusted while the concentration of the ultraviolet-photochromic polyoxometallate is maintained constant. When the users are the people who are sensitive to an ultraviolet ray such as children, the aged and women, the concentration of the electron donor may be increased properly, whereby, under the same ultraviolet irradiation, the speed of the reduction of the ultraviolet-photochromic polyoxometallate is increased, so as to accelerate the changing of the color of the ultraviolet-photochromic ink, to alert, under a low ultraviolet intensity, the people sensitive to an ultraviolet ray to make the protection. The other manner is to, according to the difference in the physiques of the users, regulate the quantities of the stacked layers of the ultraviolet-ray blocking films. For example, when the covers are the ultraviolet-ray blocking films, the quantities of the stacked layers or the thickness of the ultraviolet-ray blocking films are regulated. When the users are the people who are sensitive to an ultraviolet ray such as children, the aged and women, the users are alerted, under a low ultraviolet intensity, by reducing the quantities of the stacked layers of the ultraviolet-ray blocking films or reducing the thicknesses of the ultraviolet-ray blocking films. For example, in the ultraviolet-ray detecting device used for children, as compared with the ultraviolet-ray detecting device used for adults, the ultraviolet-ray blocking films covering the same degrees of the marking regions have lower quantities of the layers or are thinner. For example, in a region of the same ultraviolet-resistance degree, the quantity of the layers of the ultraviolet-ray blocking film covering the ultraviolet-ray detecting device used for children may be 4 layers, while the quantity of the layers of the ultraviolet-ray blocking film covering the ultraviolet-ray detecting device used for adult men may be 6 layers. Accordingly, the ultraviolet-ray detecting device whose ultraviolet-ray blocking films have low quantities of stacked layers or low thicknesses can discolor under a low ultraviolet intensity to alert the user, to prevent further sunburn.

In some embodiments, the ultraviolet-photochromic polyoxometallate may be a phosphomolybdate, and the electron donor may be at least one of oxalic acid, glycolic acid and lactic acid. Phosphomolybdate is a representative ultraviolet-photochromic polyoxometallate, and it has stable properties of color changing and reduction. Phosphomolybdate, when reduced, can change from being colorless to a gradually darkened blue color. After the mixing between the aqueous solution of the phosphomolybdate and the aqueous solution of the electron donor, under irradiation of different ultraviolet intensities, all of the oxalic acid, the glycolic acid and the lactic acid can reduce the phosphomolybdate into different intermediate products under different ultraviolet sources within 30 minutes, whereby they can emerge with different darknesses of blue color.

In some embodiments, in order to facilitate the user to intuitively see the state of the discoloration of the ultraviolet-photochromic ink, all of the identification regions 2 are marked with the same or different markers. For example, the ultraviolet-photochromic markers may be of a shape of a five-pointed star, heart-shaped or of any other shapes, to facilitate the user to observe. By using the markers having a shape, the user can more clearly acquire the information on the intensity of the ultraviolet radiation. For example, the shapes of the markers are the same shape of a five-pointed star. Under the same ultraviolet irradiation, the states of the discoloration of the ultraviolet-photochromic markers 3 in the identification regions 2 are different, and therefore the five-pointed stars in the identification regions 2 display different colors, to indicate different degrees of the intensities of the ultraviolet irradiation. The different identification regions 2 corresponds to the different ultraviolet-resistance degrees, and the different ultraviolet-resistance degrees correspond to the quantities of the stacked layers of the ultraviolet-ray blocking films.

As an example, as shown in FIGS. 1 and 2, the figures show four identification regions 2, and the present disclosure does not particularly define the quantity of the identification regions 2. With the increasing of the ultraviolet intensity, the five-pointed stars (the ultraviolet-photochromic markers 3) in the corresponding identification regions 2 change into a gradually darken blue color, and a darker blue color indicates a higher ultraviolet intensity. If the five-pointed star of the degree 1 is in the colorless state or a light-blue state, that indicates that at the moment the ultraviolet intensity is very low, and at the moment the user is in a dark environment or is indoor, and does not require an extra protection. If the five-pointed star of the degree 2 is in a blue state, that indicates that at the moment there is a certain ultraviolet irradiation, with a not very high intensity, and the user may make certain protection as appropriate, for example coating a low-expansion sunscreen. If the degree 3 is used as a preliminary-alarming degree, the bluing of the five-pointed star of this degree indicates that at the moment the ultraviolet intensity has already been in the degree that will adversely affect the skin, and ultraviolet-ray protection is required as soon as possible, for example, wearing a sun-protective clothing, coating a high-expansion sunscreen and wearing sunglasses. If the five-pointed star of the degree 4 is in a blue state, that indicates that the ultraviolet intensity at the moment will cause irreversible harm to human body, and the user requires to find a shelter as soon as possible, and make post-burning repairing, to prevent swelling and inflammation of the skin or even more serious skin scalding. Such a division of the identification regions 2 enables the user to clearly acquire the degree of the ultraviolet intensity of the current environment, and make protection by using the appropriate measures. Moreover, in some embodiments, in the fabrication of the ultraviolet-ray detecting device, the substrate 1 may be a filter paper or glass. Filter paper and glass have a low cost, and can be easily prepared, recovered or carried by the user.

The above embodiments of the present disclosure, by using the characteristic of the ultraviolet-photochromic markers of the ultraviolet-ray detecting device, i.e., the characteristic of the ultraviolet-photochromic markers that the color is darkened under an ultraviolet irradiation of a high intensity, enable the user to monitor in real time the intensities of ultraviolet irradiations in everyday life, to monitor at any time and at any place the intensity of the ultraviolet irradiation of the environment where he is located, and, when the intensity is too high, timely emit the protection alarming, and can realize customized designs for different people by regulating the component composition of the ultraviolet-photochromic ink or the thickness of the ultraviolet-ray blocking films.

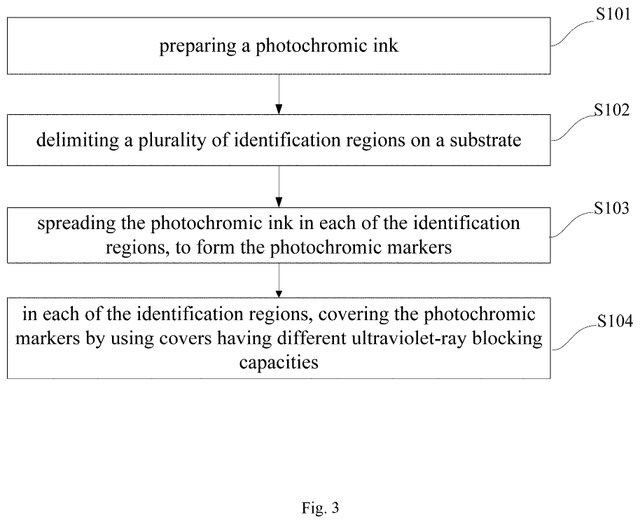

The present disclosure provides a fabricating method of an ultraviolet-ray detecting device. As shown in FIG. 3, the method comprises the following steps:

S101: preparing an ultraviolet-photochromic ink.

Regarding the step S101, the step of preparing the ultraviolet-photochromic ink comprises: providing certain volumes of an aqueous solution of an ultraviolet-photochromic polyoxometallate and an aqueous solution of an electron donor; and mixing the aqueous solution of the ultraviolet-photochromic polyoxometallate and the aqueous solution of the electron donor, whereby the electron donor reduces the ultraviolet-photochromic polyoxometallate stepwisely under a certain condition. The ultraviolet-photochromic polyoxometallate, under the conditions of the electron donor and the ultraviolet irradiation, can realize multi-step reduction, thereby obtaining a series of intermediate products of multiple valence states; in other words, the ultraviolet-photochromic polyoxometallate emerges directly with different colors, whereby the ultraviolet-photochromic ink has the characteristic that the color is darkened under an ultraviolet irradiation of a high intensity, and, thus, can, under different intensities of ultraviolet irradiations, display the colors of its different intermediate products to the user.

In some embodiments, the step of preparing the ultraviolet-photochromic ink further comprises: protecting the ultraviolet-photochromic ink that has been completely prepared from light and by using nitrogen sealing. The ultraviolet-photochromic ink may be prepared at any time for the monitoring of ultraviolet irradiations. If the ultraviolet-photochromic ink is not to be used immediately after it is prepared, considering the disadvantage of the ultraviolet-photochromic ink 3 of easy deterioration when exposed to sunlight, after the preparation of the ultraviolet-photochromic ink 3 and before the usage, it may be stored with protection from light, to effectively protect the effectiveness and the durability of the ultraviolet-photochromic ink. For example, the prepared ultraviolet-photochromic ink 3 is protected by using nitrogen, which is an inert gas.

In some embodiments, the ultraviolet-photochromic polyoxometallate is a phosphomolybdate, and the electron donor is at least one of oxalic acid, glycolic acid and lactic acid. Phosphomolybdate is a representative ultraviolet-photochromic polyoxometallate, and it has stable properties of color changing and reduction. Phosphomolybdate, when reduced, can change from being colorless to a gradually darkened blue color. In other words, after the mixing between the aqueous solution of the phosphomolybdate and the aqueous solution of the electron donor, under irradiation of different ultraviolet intensities, all of the oxalic acid, the glycolic acid and the lactic acid can reduce the phosphomolybdate into different intermediate products under different ultraviolet sources within 30 minutes, whereby they can emerge with different darknesses of blue color.

S102: delimiting a plurality of identification regions 2 on a substrate 1.

In this step, the identification regions 2 are sequentially arranged on the substrate 1. The shapes of the identification regions 2 may be rectangle, circle and another shape that can be displayed. That facilitates to provide the ultraviolet-photochromic markers 3 in each of the identification regions 2.

S103: spreading the ultraviolet-photochromic ink in each of the identification regions 2, to form the ultraviolet-photochromic markers 3.

In some embodiments, the step of delimiting the identification regions 2 on the substrate 1 that are sequentially arranged further comprises: marking each of the identification regions 2 with the same or different markers. The ultraviolet-photochromic markers may be of a shape of a five-pointed star, heart-shaped or of any other shapes, to facilitate the user to observe. By using the markers having a shape, the user can more clearly acquire the information on the intensity of the ultraviolet radiation. For example, the shapes of the markers are the same shape of a five-pointed star. Under the same ultraviolet irradiation, the states of the discoloration of the ultraviolet-photochromic markers 3 in the identification regions 2 are different, and therefore the five-pointed stars in the identification regions 2 display different colors, to indicate different degrees of the intensities of the ultraviolet irradiation.

The ultraviolet-photochromic ink itself may serve as the ultraviolet-photochromic marker. Alternatively, the ultraviolet-photochromic ink may also form the ultraviolet-photochromic marker after it has been semi-dried or dried. Preferably, the marker formed after the ink has been dried is employed, which facilitates the subsequent covering by the cover. The drying is the process in which the water in the ink is evaporated, and may be completed by natural air drying or by heating.

S104: in each of the identification regions 2, covering the ultraviolet-photochromic markers 3 by using covers 4 having different ultraviolet-ray blocking capacities.

The user can acquire the intensity of the ultraviolet irradiation of the current environment with naked eye according to the colors of the ultraviolet-photochromic markers 3 in the different identification regions 2. When the intensity of the ultraviolet irradiation is too high, the user can make protection according to his own condition, to prevent the irradiation of the ultraviolet ray of the high intensity. The component composition of the ultraviolet-photochromic ink may be varied, to provide suitable ultraviolet-photochromic markers 3 according to the different conditions of the users.

Further, each of the identification regions 2 provided with the ultraviolet-photochromic markers 3 used for marking is covered by ultraviolet-ray blocking films 5 having different quantities of stacked layers. The different identification regions 2 correspond to the ultraviolet-ray blocking films having the different quantities of the stacked layers. The ultraviolet-ray blocking film has a certain light transmittance, to enable the ultraviolet ray of a certain intensity to pass through the ultraviolet-ray blocking film, and also has a certain opacity. In other words, each layer of the ultraviolet-ray blocking films blocks or obstructs an ultraviolet ray. Higher quantities of the stacked layers of the ultraviolet-ray blocking films have more obvious effect of the blocking or obstructing.

In some embodiments, the identification regions 2 on the substrate 1 may be arranged in a sequence in which the quantities of the stacked layers of the covering ultraviolet-ray blocking films 5 are progressively increased or progressively reduced. In other words, the different identification regions 2 arranged in a sequence are covered by the ultraviolet-ray blocking films 5 whose quantities of the layers are progressively increased or progressively reduced, so that the darknesses of the colors of the ultraviolet-photochromic markers 3 are changed in a certain sequence. That facilitates the user to determine the irradiation intensity of an ultraviolet ray by observing the discoloration of the identification regions 2. In addition, the quantities of the stacked layers of the ultraviolet-ray blocking films 5 in the different identification regions 2 may be set according to requirements by the measurement by the user, to increase the adaptability of the product.

The cover may be formed by using any suitable ultraviolet-ray blocking materials. The cover may be provided in various suitable manners, for example, lamination.

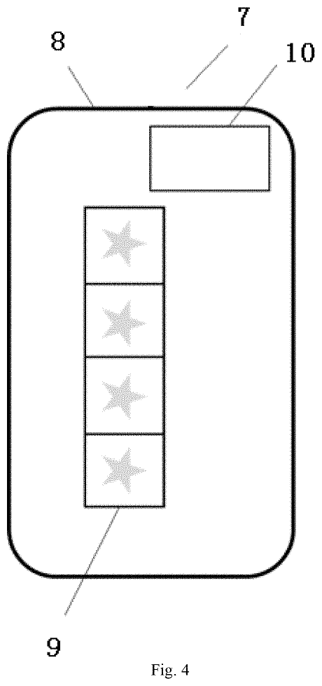

The present disclosure further provides a smart apparatus. As shown in FIG. 4, the smart apparatus 7 comprises a housing 8, and further comprises the ultraviolet-ray detecting device 9 stated above. The ultraviolet-ray detecting device 9 is arranged on the side of the housing 8 that is irradiated by light, whereby the ultraviolet-ray detecting device 9 can timely feed back the intensity of the ultraviolet irradiation of the environment where the user is located. The smart apparatus 7, by using the characteristic of the ultraviolet-photochromic markers 3 of the ultraviolet-ray detecting device 9, i.e., the characteristic of the ultraviolet-photochromic markers 3 that the color is darkened under an ultraviolet irradiation of a high intensity, enables the user to monitor in real time the intensities of ultraviolet irradiations in everyday life, to monitor at any time and at any place the intensity of the ultraviolet irradiation of the environment where he is located, and, when the intensity is too high, timely emits the protection alarming, and can realize customized designs for different people by regulating the component compositions of the ultraviolet-photochromic markers 3 or the quantities of the stacked layers of the ultraviolet-ray blocking films. The smart apparatus 7 may be a portable electronic smart apparatus such as a hang decoration or a bracelet, and may also be combined with another electronic device, which is not particularly limited in the present application.

In some embodiments, the smart apparatus 7 further comprises an image collecting component 10 (as shown in FIG. 4) configured for collecting image information of the displaying result of the ultraviolet-ray detecting device 9; and a data analyzing component configured for, according to the image information, acquiring intensity information of an ultraviolet ray, and determining whether the intensity information exceeds a preset threshold, and if yes, generating an alerting signal. The image collecting component 10 may be an existing component of the smart apparatus 4, for example a camera in a mobile phone, or another product that can collect an image and is dedicated to collect the displaying result of the ultraviolet-ray detecting device 9. The data analyzing component can timely alert the user, to prevent that the user does not timely notice the changing of the degree displayed on the ultraviolet-ray detecting device 9, and thus misses the optimal time of protection, whereby resulting in skin injury.

In some embodiments, the smart apparatus 7 further comprises an alarming device configured for emitting alerting information according to the alerting signal. The alarming device comprises a sound alarming device and/or a displaying alarming device. The smart apparatus 7 emits visual alarming information by using the alarming device to directly alert the user. The alarming information may also be sound alarming information, to prevent that the user does not see the displayed contents of the smart apparatus 7, to improve the usage experience of the user.

In some embodiments, the smart apparatus 7 further comprises a storing component configured for storing intensity information, time information and location information corresponding to the image information. If, next time, the user enters the same location at the same time, even if the user does not start up the above-described ultraviolet-ray sensor, the smart apparatus 4 can give warning according to the intensity information stored by the storing component that corresponds to the current time and the current location, and the user may make protection as appropriate, which effectively improves the function and the intelligence of the smart apparatus 7.

In some embodiments, the smart apparatus 7 further comprises a data-connection component configured for connecting wirelessly to a mobile terminal of the user or a cloud device, to share the data. Other users may acquire the information on the ultraviolet intensity corresponding to the time and the location by using the cloud, to plan the particular travelling routine, to realize information sharing.

In some embodiments, in order to facilitate the installation and detaching of the ultraviolet-ray detecting device in the electronic device, the ultraviolet-ray detecting device 9 is detachably arranged at the housing 8, to facilitate the usage and the operation of the user, and the user may selectively use it according to his practical demands.

In some embodiments, a plug slot is provided at the housing 8, and the ultraviolet-ray detecting device 9 is arranged at the housing 8 via the plug slot. The ultraviolet-photochromic markers 3 in the identification regions 2 on the ultraviolet-ray detecting device 9 are required to be exposed in usage, to prevent affecting the effect of the discoloration of the ultraviolet-photochromic ink. The plug slot has a simple structure, and is easily operable by the user.

Over the prior art, the advantageous effects of the present disclosure are as follows. The present disclosure, by using the characteristic of the ultraviolet-photochromic ink of the ultraviolet-ray detecting device, i.e., the characteristic of the ultraviolet-photochromic ink that the color is darkened under an ultraviolet irradiation of a high intensity, enables the user to monitor in real time the intensities of ultraviolet irradiations in everyday life, to monitor at any time and at any place the intensity of the ultraviolet irradiation of the environment where he is located, and, when the intensity is too high, timely emits the protection alarming, and can realize customized designs for different people by regulating the component composition of the ultraviolet-photochromic ink or the thickness of the ultraviolet-ray blocking films. Especially, the ultraviolet-ray detecting device and the smart apparatus according to the present disclosure do not require a colorimetric card or a similar device. The product according to the present disclosure, by using the covers having the different ultraviolet-ray blocking capacities, has at the same time the plurality of identification regions that discolor under different ultraviolet intensities, and thus can enable the user to easily know the ultraviolet intensity by the sequential discoloration of the plurality of identification regions in environments whose ultraviolet rays are gradually intensified. Moreover, the customization by using the component composition of the ink or the quantity of the stacked layers of the ultraviolet-ray blocking films is particularly convenient and cheap. Furthermore, as compared with using different ultraviolet-photochromic markers for different ultraviolet intensities, the mode of the present disclosure of using the same ultraviolet-photochromic marker but using the different covers simplifies the preparation.

Moreover, although exemplary embodiments have already been described herein, the scope of the present disclosure encompasses any and all embodiments on the basis of the present disclosure that have the equivalent elements that have been modified, omitted, combined (example, solutions in which the embodiments are overlapped), adapted or changed. The elements of the claims will be interpreted broadly on the basis of the expressions used in the claims, and are not limited to the examples described in the description or during the implementation of the present application, and the examples will be interpret as non-exclusive. Therefore, the description and the examples are intended to merely be considered as illustrative, and the true scope and spirit are defined by the whole scope of the claims and the equivalents thereof.

The above description is intended to be illustrative rather than limiting. For example, the above examples (or one or more solutions thereof) may be combined with each other. For example, a person skilled in the art may use other embodiments when reading the above description. In addition, in the above particular embodiments, the features may be grouped together to simplify the present disclosure. That should not be interpreted as the intention that a disclosed feature that is not claimed is necessary for any one of the claims. In contrast, the subject matter of the present disclosure may have features less than all of the features of the particularly disclosed embodiments. Therefore, the claims are incorporated into the particular embodiments as examples or embodiments, wherein each of the claims independently serves as an individual embodiment, and those embodiments may be combined with each other in various combinations or arrangements. The scope of the present disclosure should be determined on the basis of the whole scope of the appended claims and the equivalents of the claims.

The above embodiments are merely exemplary embodiments of the present disclosure, and are not intended to limit the present disclosure, and the protection scope of the present disclosure is defined by the claims. A person skilled in the art may make various modifications or equivalent substitutions to the present disclosure within the essence and the protection scope of the present disclosure, and such modifications or equivalent substitutions should be considered as also falling within the protection scope of the present disclosure.

1. An ultraviolet-ray detecting device, wherein the ultraviolet-ray detecting device comprises:
a substrate, wherein the substrate comprises a plurality of identification regions; and
an ultraviolet-photochromic marker and a cover covering the ultraviolet-photochromic marker that are in each of the identification regions, wherein ultraviolet-ray blocking capacities of the covers in the identification regions are different.

2. The ultraviolet-ray detecting device according to claim 1, wherein the ultraviolet-photochromic marker is formed by an ultraviolet-photochromic ink, wherein the ultraviolet-photochromic ink is a mixture of an aqueous solution of an ultraviolet-photochromic polyoxometallate and an aqueous solution of an electron donor.

3. The ultraviolet-ray detecting device according to claim 2, wherein a ratio of molar concentrations of the aqueous solution of the ultraviolet-photochromic polyoxometallate to the aqueous solution of the electron donor is in a range of 1:10 to 1:120.

4. The ultraviolet-ray detecting device according to claim 2, wherein the ultraviolet-photochromic polyoxometallate is a phosphomolybdate.

5. The ultraviolet-ray detecting device according to claim 2, wherein the electron donor is at least one of oxalic acid, glycolic acid and lactic acid.

6. The ultraviolet-ray detecting device according to claim 1, wherein the covers having the different ultraviolet-ray blocking capacities are ultraviolet-ray blocking films having different quantities of stacked layers.

7. The ultraviolet-ray detecting device according to claim 6, wherein the plurality of identification regions are arranged so that the quantities of the stacked layers of the ultraviolet-ray blocking films in the identification regions are progressively increased or progressively reduced in an arranging sequence.

8. The ultraviolet-ray detecting device according to claim 6, wherein the ultraviolet-ray blocking films are marked with ultraviolet-resistance degrees based on the quantities of the stacked layers.

9. A smart apparatus, comprising a housing, wherein the smart apparatus further comprises the ultraviolet-ray detecting device according to claim 1, and the ultraviolet-ray detecting device is arranged at the housing.

10. The smart apparatus according to claim 9, wherein the smart apparatus further comprises:
an image collecting component configured for collecting image information of the ultraviolet-photochromic markers of the ultraviolet-ray detecting device; and
a data analyzing component configured for, according to the image information, acquiring intensity information of an ultraviolet ray, determining whether the intensity information exceeds a preset threshold, and when the preset threshold is exceeded, generating an alerting signal.

11. The smart apparatus according to claim 10, wherein the smart apparatus further comprises an alarming device configured for, according to the alerting signal, emitting alarming information, wherein the alarming information comprises sound alarming information and/or visual alarming information.

12. The smart apparatus according to claim 9, wherein the ultraviolet-ray detecting device is detachably arranged at the housing.

13. A fabricating method of an ultraviolet-ray detecting device, wherein the method comprises:
preparing an ultraviolet-photochromic ink;
delimiting a plurality of identification regions on a substrate;
spreading the ultraviolet-photochromic ink in each of the identification regions, to form ultraviolet-photochromic markers; and
in the identification regions, covering the ultraviolet-photochromic markers by using covers having different ultraviolet-ray blocking capacities.

14. The fabricating method according to claim 13, wherein the step of preparing the ultraviolet-photochromic ink comprises:
providing an aqueous solution of an ultraviolet-photochromic polyoxometallate and an aqueous solution of an electron donor; and
mixing the aqueous solution of the ultraviolet-photochromic polyoxometallate and the aqueous solution of the electron donor.

15. The fabricating method according to claim 14, wherein after the step of preparing the ultraviolet-photochromic ink and before the step of spreading the ultraviolet-photochromic ink in each of the identification regions to fabricate the markers, the method comprises protecting the ultraviolet-photochromic ink from light and by using nitrogen sealing.
